(19) United States
(12) Patent Application Publication
(10) Pub. No.: US 2023/0315064 A1
(43) Pub. Date: Oct. 5, 2023

(54) NETWORK SYSTEM, COMMUNICATION METHOD, AND COMPUTER READABLE MEDIUM

(71) Applicant: Mitsubishi Electric Corporation, Tokyo (JP)

(72) Inventors: Futoshi HIROSE, Tokyo (JP); Daisuke OSAGAWA, Tokyo (JP)

(73) Assignee: Mitsubishi Electric Corporation, Tokyo (JP)

(21) Appl. No.: 18/207,196

(22) Filed: Jun. 8, 2023

Related U.S. Application Data
(63) Continuation of application No. PCT/JP2021/005090, filed on Feb. 10, 2021.

(51) Int. Cl. G05B 19/418

(52) U.S. Cl. CPC G05B 19/4185; G05B 2219/2231; G05B 2219/21043

(57) ABSTRACT

A slave station (102), in an initial state, puts a relay device to a relay-disconnected status and transmits an assignment request requesting address assignment for the own slave station. A master station (101), in response to an assignment request from an adjacent slave station (102), performs address assignment for the slave station (102), and transmits an assignment request response containing an assigned address. The slave station (102), upon reception of the assignment request response, stores the address contained in the assignment request response to a memory, and puts the relay device to a relay status. If the slave station (102) receives the assignment request after address assignment for the slave station is completed, the slave station performs address assignment for a slave station being a sender of the assignment request instead of relaying the assignment request, and transmits an assignment request response containing an assigned address.

### CROSS REFERENCE TO RELATED APPLICATIONS

This application is a Continuation of PCT International Application No. PCT/JP2021/005090, filed on Feb. 10, 2021, which is hereby expressly incorporated by reference into the present application.

### TECHNICAL FIELD

The present disclosure relates to a network system, a communication method, and a communication program.

### BACKGROUND ART

Some control network equipment used for remote control of an embedded device assigns an address to the device manually at the time of installation. However, when assigning an address manually, a problem of erroneous setting is likely to occur. In addition, if the network is reorganized due to reorganization of a device or due to addition of a device, address assignment must be performed again each time, which takes time and effort.

Dynamic host configuration protocol (DHCP) is used as a general means for automatic address assignment of network equipment. In DHCP, a master station (DHCP server) which assigns a network address performs address assignment using an inherent address of a slave device (DHCP client) which is the address assignment target. The master station assigns an arbitrary network address to each slave station using a correspondence table recorded with a relationship between inherent addresses and addresses to be assigned. The inherent address currently referred to signifies a MAC address layer 2 protocol of the generally used Ethernet (registered trademark).

Meanwhile, in the aforementioned control network, there are many slave station devices that do not use Ethernet (registered trademark) or that do not have inherent addresses because addresses have been assigned to them manually. With respect to automatic address assignment in such devices and the network, Patent Literature 1 discloses an address assignment method in a daisy-chain-connected network. In the method disclosed in Patent Literature 1, each slave station has communication ports that can be connected to communication ports of another slave station. Patent Literature 1 discloses a technique according to which, in a network device having a function of relaying communication ports and a means capable of switching the relay function between disconnection and relay by an arbitrary method, a master station assigns an address while controlling the relay function.

### CITATION LIST

### Patent Literature

Patent Literature 1: JP 2008-278179 A

### SUMMARY OF INVENTION

### Technical Problem

In the address assignment method disclosed in Patent Literature 1, an address assignment process by a master is performed. Therefore, a load of management processing such as generation and maintenance of addresses is concentrated on the master. Also, in a tree-connected network, slave stations need to hold a routing means for grasping device positions at the time of address assignment, and a routing table that increases with the number of slave stations.

In Patent Literature 1, there are a master station that performs address setting and management, and a plurality of slave stations to which addresses are to be set. Patent Literature 1 discloses an automatic address assignment method for these stations, and a station exchange method that works when a slave station fails. However, in Patent Literature 1, a human being is involved in detection of station exchange and start of address reassignment, and accordingly manual processing remains. In addition, there is a problem that the processing load of address assignment is concentrated on the master station.

The present disclosure makes it possible to automatically assign an address to a slave station not having an inherent address on a basis of a connection relationship between communication stations such as between a master station and a slave station. The present disclosure also makes it possible to automatically detect exchange or addition of a communication station, and to assign an arbitrary address to the detected communication station. The objective of the present disclosure is hence to thereby provide automatic address assignment means that does not involve a human being.

### Solution to Problem

A network system according to the present disclosure is a network system formed of a plurality of communication stations,
wherein the plurality of communication stations include a master station having one or more communication ports and a slave station having two or more communication ports,
wherein each communication station of the plurality of communication stations comprises a relay device which relays two or more communication ports of the communication station and which can be put to a relay-disconnected status,
wherein the slave station, in an initial state, puts the relay device to the relay-disconnected status and transmits an assignment request requesting address assignment for the slave station,
wherein the master station, in response to an assignment request from an adjacent slave station, performs address assignment for the slave station, and transmits an assignment request response containing an assigned address,
wherein the slave station, upon reception of the assignment request response, stores the address contained in the assignment request response to a memory, and puts the relay device to a relay status, and
wherein if the slave station receives the assignment request after address assignment for the slave station is completed, performs address assignment for a slave station being a sender of the assignment request instead of relaying the assignment request, and transmits an assignment request response containing an assigned address.

### Advantageous Effects of Invention

In a network system according to the present disclosure, address assignment can be performed for a slave station appropriately by a communication station adjacent to the slave station. Therefore, with the network system according to the present disclosure, address assignment can be performed for a slave station not having an inherent address, while avoiding concentration of a processing load to the master station.

### BRIEF DESCRIPTION OF DRAWINGS

FIG. 1 is a diagram illustrating an example of a configuration of a communication station according to Embodiment 1.

FIG. 2 is a diagram illustrating another example of the configuration of the communication station according to Embodiment 1.

FIG. 3 is a diagram illustrating a network configuration example 1 of a network system that uses the communication station according to Embodiment 1.

FIG. 4 is a diagram illustrating a network configuration example 2 of the network system that uses the communication station according to Embodiment 1.

FIG. 5 is a diagram illustrating a network configuration example 3 of the network system that uses the communication station according to Embodiment 1.

FIG. 6 is a sequence diagram illustrating a communication process of a network system according to Embodiment 1.

FIG. 7 is a sequence diagram illustrating the communication process of the network system according to Embodiment 1.

FIG. 8 is a sequence diagram illustrating a communication process of a network system according to Embodiment 2.

FIG. 9 is a diagram illustrating a network configuration example 4 according to Embodiment 3.

FIG. 10 is a sequence diagram illustrating a communication process of a network system according to Embodiment 3.

FIG. 11 is a sequence diagram illustrating the communication process of the network system according to Embodiment 3.

FIG. 12 is a sequence diagram illustrating the communication process of the network system according to Embodiment 3.

FIG. 13 is a sequence diagram illustrating the communication process of the network system according to Embodiment 3.

FIG. 14 is a diagram illustrating a state where an address assignment process has been performed for a network configuration example 4 according to Embodiment 4.

FIG. 15 is a sequence diagram illustrating a communication process of a network system according to Embodiment 5.

FIG. 16 is a sequence diagram illustrating a communication process of a network system according to Embodiment 6.

FIG. 17 is a diagram illustrating a state where an address assignment process has been performed for a network configuration example 4 according to Embodiment 7 and a slave station 6 is inserted in the network configuration example 4.

FIG. 18 is a sequence diagram illustrating a communication process of a network system according to Embodiment 7.

### DESCRIPTION OF EMBODIMENTS

Embodiments will be described below with referring to diagrams. In the drawings, the same or equivalent parts are denoted by the same reference sign. In description of the embodiments, description of the same or equivalent parts will appropriately be omitted or simplified.

### Embodiment 1

***Description of Configurations***

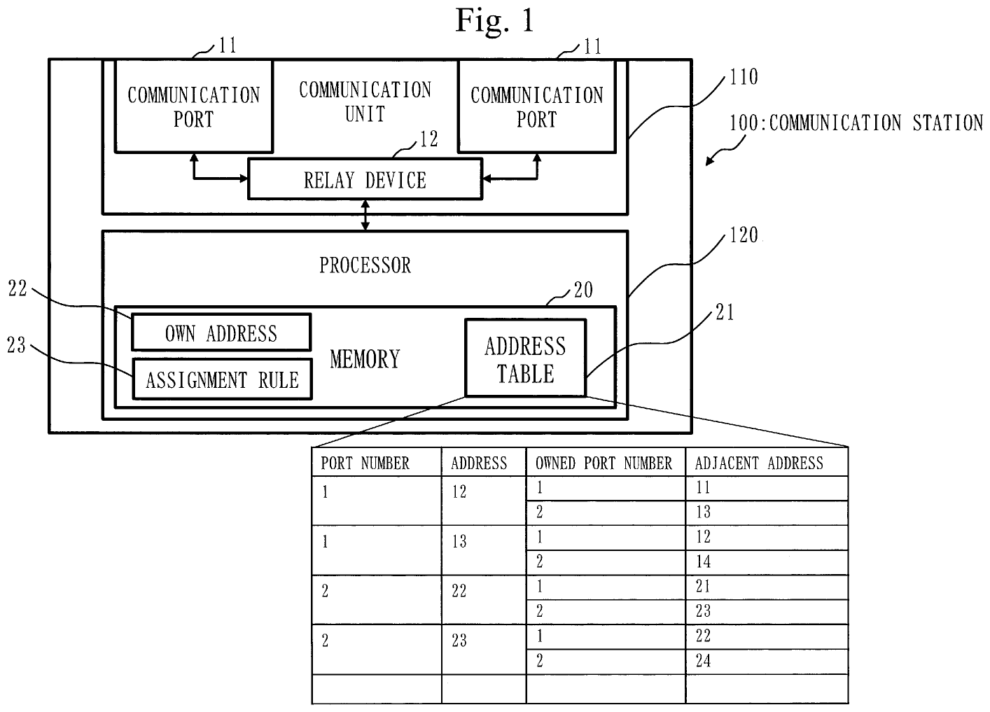

FIG. 1 presents an example of a configuration of a communication station 100 according to the present embodiment.

The communication station 100 is network equipment provided to a network system 500.

The communication station 100 is provided with a communication unit 110 and a processor 120 which controls the communication station 100. The processor 120 is a CPU. CPU stands for central processing unit. Although not illustrated, the communication station 100 is provided with a non-volatile storage device.

The communication unit 110 is provided with a communication port 11. If the communication unit 110 has two or more communication ports 11, the communication unit 110 has a communication control computer which is a relay device 12 to relay the communication ports 11. The relay device 12 can relay or disconnect a plurality of communication ports 11.

The processor 120 is provided with a memory 20. An address table 21, an own address 22, and an assignment rule 23 are stored in the memory 20.

The network system 500 uses the communication station 100 as network equipment. The network system 500 is constituted of one or more master stations and one or more slave stations. The network system 500 has a daisy-chain-connected or tree-connected network. The master station has one or more communication ports 11. The slave station has two or more communication ports 11. Even when a relay function of the communication port 11 is disconnected, the processor 120 of the slave station, or the communication control microcomputer which is the relay device 12, can analyze communication data.

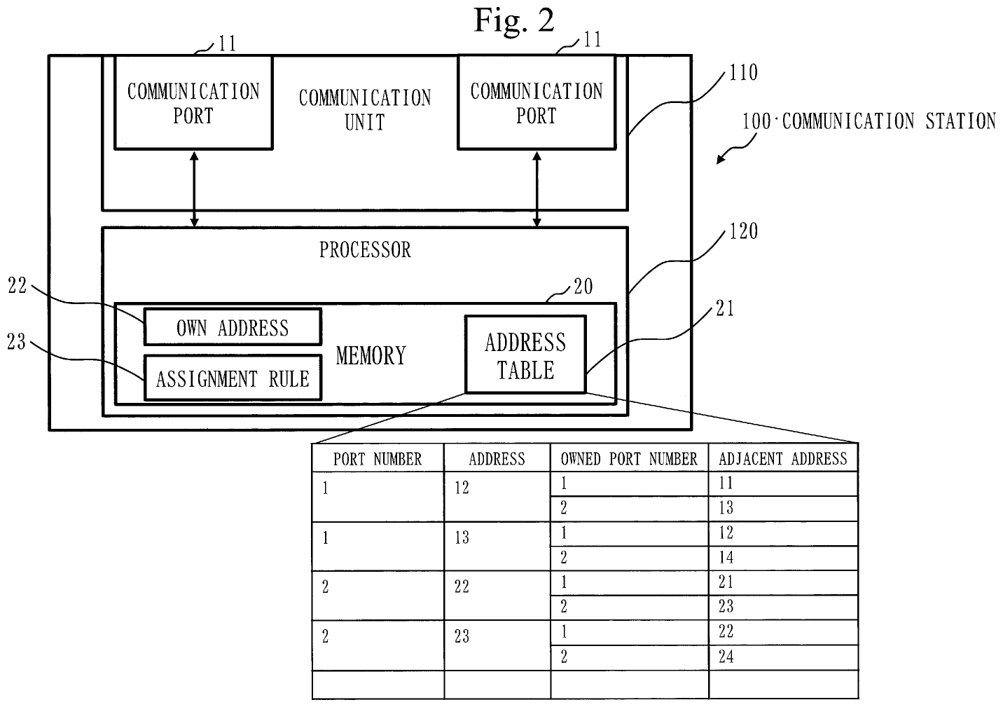

FIG. 2 presents another example of the configuration of the communication station 100 according to the present embodiment.

As illustrated in FIG. 1, the relay device 12 can be implemented in a communication circuit of the communication unit 110 as the communication control microcomputer. Alternatively, as illustrated in FIG. 2, a circuit configuration may be possible in which a processor 120 to control communication ports 11 is provided with a function of a relay device that decides whether or not relay can be made.

Two communication ports are illustrated in FIGS. 1 and 2. However, three or more communication ports may be provided, and each communication port may have a relay function that can switch the communication port between relay and disconnection.

In each communication station 100, the communication ports 11 are daisy-chain-connected or tree-connected via a communication line. The communication ports 11 provided to the communication station 100 can detect that the communication line is connected.

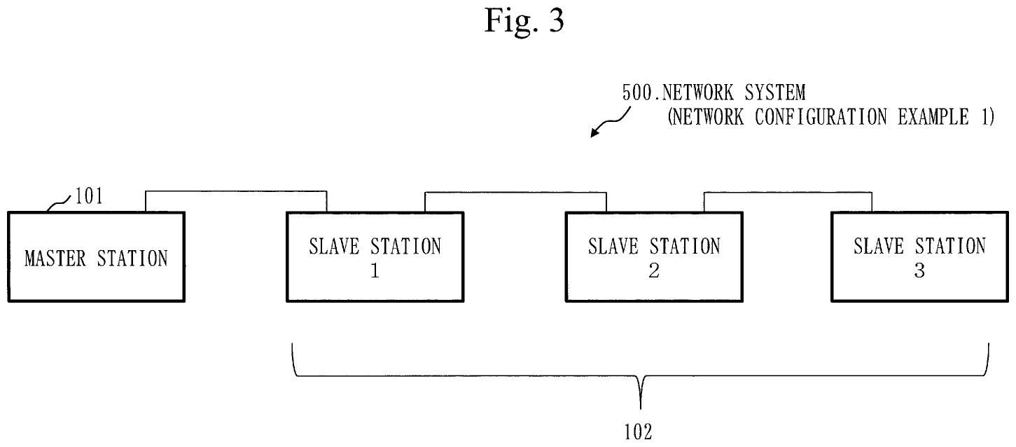

FIG. 3 presents a network configuration example 1 of the network system 500 that uses the communication station 100 according to the present embodiment.

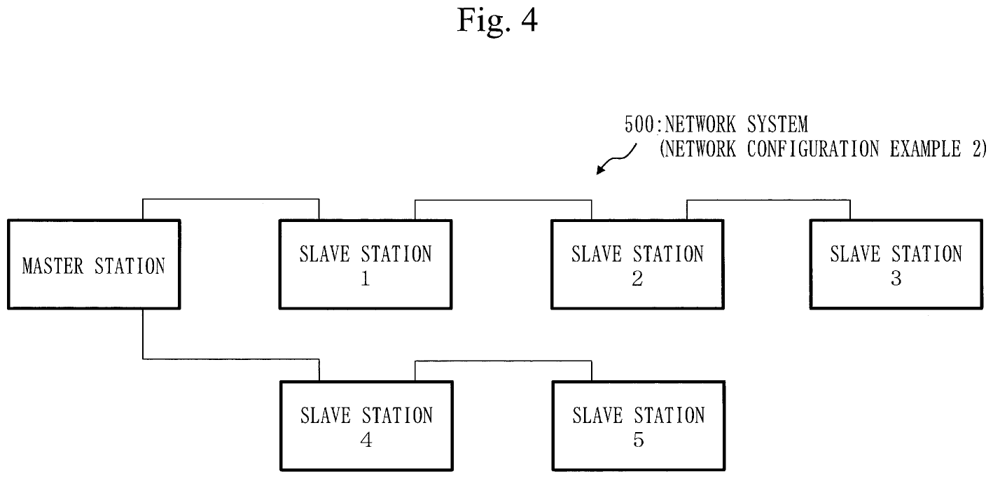

FIG. 4 presents a network configuration example 2 of the network system 500 that uses the communication station 100 according to the present embodiment.

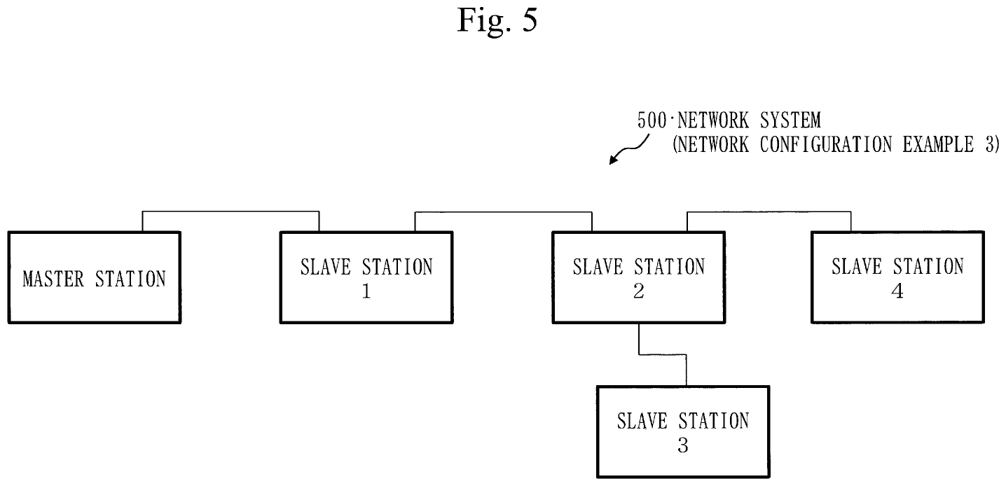

FIG. 5 presents a network configuration example 3 of the network system 500 that uses the communication station 100 according to the present embodiment.

In the example of FIG. 3, one master station 101 and three slave stations 102 are connected. Depending on a number of ports of the communication station 100, connection patterns other than the connection pattern in FIG. 3 are available. FIG. 4 illustrates a case where a master station has two communication ports. FIG. 5 illustrates a case where a slave station has three or more ports.

Also, port numbers, addresses, owned port numbers, and adjacent addresses are preset in the address table 21 of FIG. 1. The address table 21 is a table to store address information and a communication port connection relationship. A number of items that can be registered with the address table 21 is variable. At startup time, the address table 21 is empty. The address table 21 can be re-used for second and subsequent startup if it is saved in a non-volatile storage device when the system is ended.

****Description of Operations***

Next, operations of the network system 500 according to the present embodiment will be described. An operation procedure of the network system 500 corresponds to a communication method used in the network system 500. A program that implements the operations of the network system 500 corresponds to a communication program used in the network system 500.

The communication program is run by the processor 120 of the communication station 100. That is, a function of the network system 500 according to the present embodiment is implemented by cooperation of hardware such as the communication unit, the processor, and the memory which are provided to the communication station 100. The hardware such as the processor and the memory 20 that implements the function of the network system 500 according to the present embodiment is also called processing circuitry.

The network system 500 according to the present embodiment has the network configuration example 1 of FIG. 3.

In the network system 500, after startup, if no address information has been preset and saved in the storage device in the past, the communication station 100 empties the address table 21. If address information has been preset and saved in the storage device in the past, the communication station 100 reads the address information onto the address table 21 and uses the address information. Also, relay devices of the slave stations are put to a relay-disconnected status.

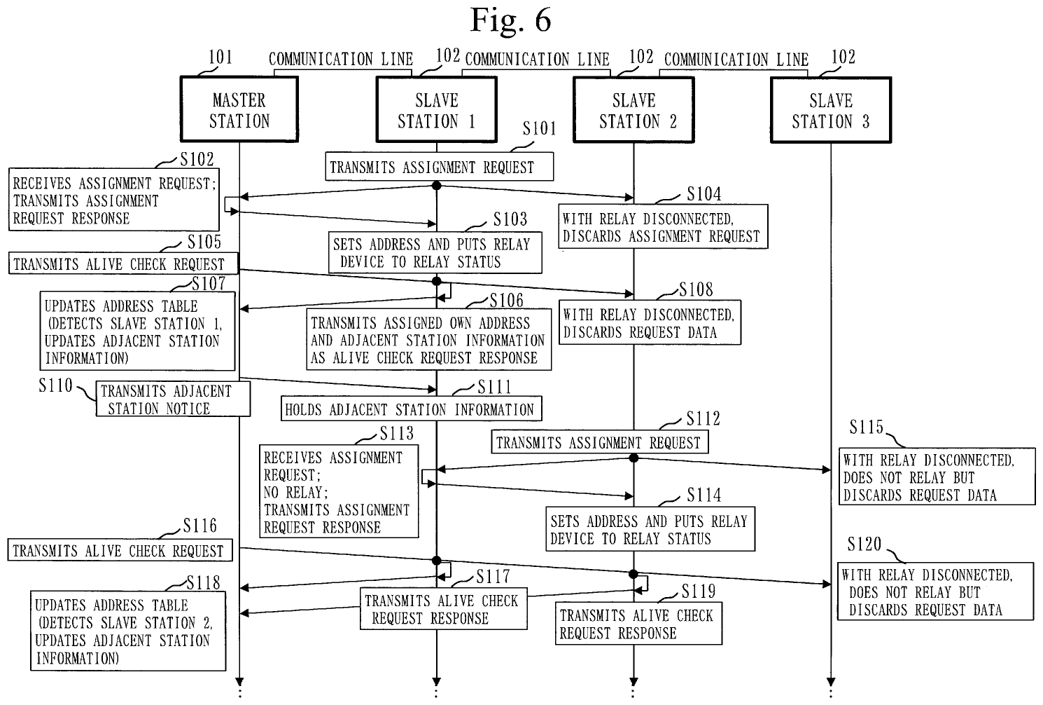

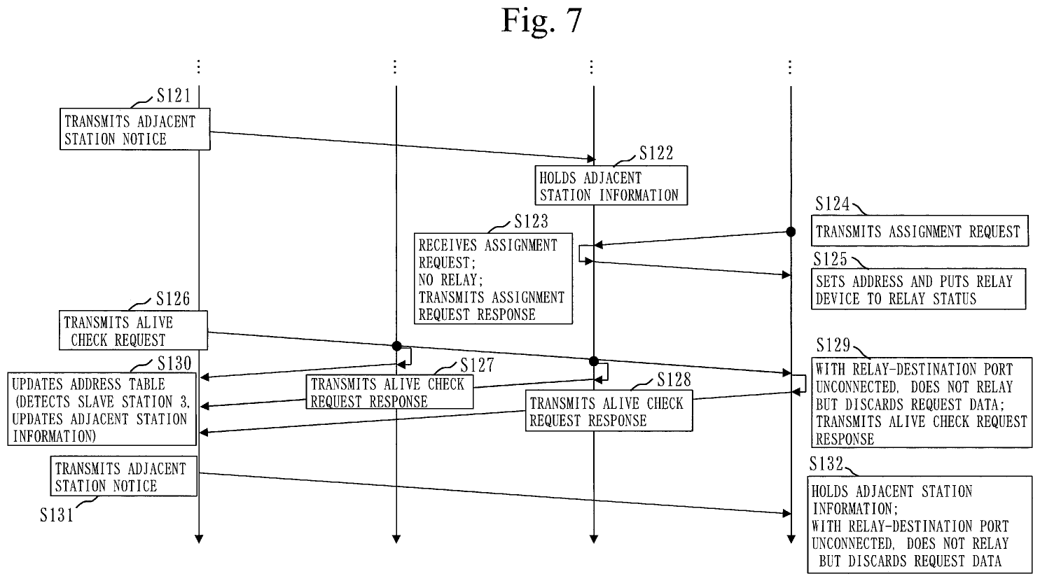

FIGS. 6 and 7 are sequence diagrams illustrating a communication process of the network system 500 according to the present embodiment. Note that FIGS. 6 and 7 are consecutive sequence diagrams.

FIGS. 6 and 7 illustrate an address assignment process which is a communication process in the network configuration example 1 of FIG. 3.

An overview of the address assignment process in FIGS. 6 and 7 will be described.

The network system 500 is a system formed of a plurality of communication stations. The plurality of communication stations include a master station having one or more communication ports and a slave station having two or more communication ports. Each communication station of the plurality of communication stations is provided with a relay device which relays two or more communication ports of the communication station and which can be put to the relay-disconnected status.

The slave station, in an initial state, puts the relay device to the relay-disconnected status and transmits an assignment request requesting address assignment for the slave station.

The master station, in response to an assignment request from an adjacent slave station, performs address assignment for the slave station, and transmits an assignment request response containing an assigned address.

The slave station, upon reception of the assignment request response, stores the own address contained in the assignment request response to a memory, and puts the relay device to a relay status.

If the slave station receives the assignment request after address assignment for the slave station is completed, the slave station performs address assignment for a slave station being a sender of the assignment request instead of relaying the assignment request even if the relay device is in the relay status, and transmits an assignment request response containing an assigned address.

Each communication station of the plurality of communication stations stores an assignment rule expressing an address assignment rule to the memory.

The communication station such as the master station and the slave station performs address assignment for the slave station being the sender of the assignment request according to the assignment rule.

The master station transmits an alive check request.

The slave station, upon reception of the alive check request, relays the alive check request if the slave station is capable of relay, and transmits an alive check request response containing its own address.

The slave station, if in the relay-disconnected status, does not relay the alive check request or the assignment request but discards them.

The master station detects existence of the slave station being the sender of the alive check request response, acquires a connection relationship of the existence-detected slave station, as adjacent station information on a basis of the alive check request response from the slave station being the sender, and communicates the adjacent station information to the slave station.

The adjacent station information is connection information with respect to a station which each slave device is adjacent to. For example, the adjacent station information is information telling that an address-4 slave station is connected to a communication port 1 side of an address-5 slave station and an address-6 slave station is connected to a communication port 2 side of the address-5 slave station. The master station broadcasts the alive check request, thereby collecting the adjacent station information from a response-capable slave station, that is, a slave station to which an address is already assigned.

The address table 21 is generated by the master station on a basis of the adjacent station information collected in the master station by the alive check request response described above. The address table 21 of the master station is delivered to the slave station as appropriate.

The slave station may have the same address table 21 as that of the master station. Considering a memory capacity and so on, however, sometimes the master station sends a partial (only a range adjacent to the slave station X) address table. In the latter case, the slave station already has the address table 21, and the master station transmits the partial address table 21 just for confirmation. As the master station has all information, it checks if there is any disagreement.

The address assignment process in FIGS. 6 and 7 will now be described specifically.

It is not identified which port of each slave station the master station is connected to. Hence, each slave station transmits an address assignment request to all its ports at fixed intervals using a timer or the like (step S101). The assignment request is also called an address assignment request.

At this time, slave stations that are not the master station discard the assignment request because relay devices are in the relay-disconnected status after startup is ended (step S104).

The master station, upon reception of the assignment request from an adjacent slave station (a slave station 1 in FIG. 6), determines an address to be assigned to the slave station (the slave station 1 in FIG. 6) from a start address initially set in the master station and from the assignment rule. Then, the master station sends an assignment request response containing the determined address via the communication port at which the assignment request was received (step S102). The assignment rule is a rule to generate a subsequent address such as addition and subtraction with respect to the initially set start address. The assignment rule is sent to an adjacent communication station as an assignment request response together with the generated address. In the following, an adjacent communication station may be called an adjacent station. The assignment rule need not be delivered if a rule unified in the network system has been inputted to the individual communication stations in advance.

The adjacent slave station receives and analyzes the assignment request response. The slave station that has accepted the assignment request response uses the assigned address as its own address, and if an assignment rule exists, holds the assignment rule. The adjacent station that has accepted the assignment request response puts the relay device to the relay status, and stores the communication port at which the assignment request response was accepted (step S103).

The slave station 1 accepts an adjacent station notice (step S110) transmitted from the master station and updates its own address table (step S111).

In the initial state, it is not identified which communication port of a slave station 2 is near the master station, as with the slave station 1. Hence, the slave station 2 transmits an assignment request via all its ports at fixed intervals using a timer or the like (step S112).

The slave station 1 receives the assignment request, calculates an address to be assigned to the slave station 2 by referring to its own address and the assignment rule, and transmits an assignment request response via its communication port at which the assignment request was received. The assignment request response contains the address to be assigned to the slave station 2 and the assignment rule. The slave station that has received the assignment request does not relay the assignment request (step S113).

The slave station that has received the assignment request response assigns an address to itself on a basis of the received assignment request response, and holds the assignment rule (step S114).

The assignment request transmitted by the slave station 2 is received by a slave station 3 as well. However, as the slave station 3 is in a relay-disconnected status, the slave station 3 discards the assignment request and does not return an assignment request response to the slave station 2 (step S115).

The slave station 3 has two or more communication ports. However, only one communication line is connected to the slave station 3. Thus, in FIG. 3, the assignment request is transmitted via one communication port to which the communication line is connected (step S123).

The slave station 2 accepts the assignment request and returns an assignment request response by the method mentioned above (step S124).

The slave station 3 that has accepted the assignment request response puts the relay device to the relay status, and holds setting of its own address and the assignment rule (step S125).

The master station transmits an alive check request periodically to all slave stations by timer control (steps S105, S116, S126).

The slave station that has accepted the alive check request checks whether address assignment for the slave station itself is completed and whether the slave station is in the relay status. The slave station then includes the assigned its own address and adjacent station information it grasps into an alive check request response, and transmits the alive check request response to the master station (steps S106, S117, S119, S127, S128, S129). If address assignment is not completed and the slave station is in the relay-disconnected status, the slave station does not respond (steps S108, S120, S129). The adjacent station information contains its communication port and an adjacent station address of an adjacent station which is connected to the communication port.

Depending on the setting intervals of timer control, an alive check request may be transmitted during an address assignment flow, and a slave station may receive the alive check request. In this case, only a slave station for which address setting is completed and which is in the relay status responds. In step S129, since a relay-destination connection port is not connected to the slave station 3, the slave station 3 does not relay the alive check request being request data but discards it, and transmits an alive check request response.

The master station that has accepted the alive check request response detects that the slave station which is the sender participates in the network. Then, the master station updates an address list of the address table and adjacent station information of relevant addresses (steps S107, S118, S130).

Having updated the adjacent station information, the master station transmits to a slave station having an address corresponding to the update, an adjacent station notice containing an adjacent station address of that slave station (steps S110, S121, S131).

The slave station that has received the adjacent station notice holds its own adjacent station information (steps S111, S122, S132).

With the above address assignment process which is a communication process of the network system 500, it is possible to perform address assignment on the basis of the connection relationship even if the slave station does not have an inherent address.

***Detailed Description of Hardware***

The hardware of the communication station will now be described in detail.

The processor is a device that runs the communication program. The communication program is also referred to as address assignment program.

The processor is an integrated circuit (IC) which performs computation processing. Specific examples of the processor are a central processing unit (CPU), a digital signal processor (DSP), and a graphics processing unit (GPU).

The memory is a storage device that stores data temporarily. A specific example of the memory is a static random-access memory (SRAM) or a dynamic random-access memory (DRAM).

The non-volatile storage device is also called auxiliary storage device. A specific example of the auxiliary storage device is an HDD. The auxiliary storage device may be a portable storage medium such as an SD (registered trademark) memory card, a CF, a NAND flash, a flexible disk, an optical disk, a compact disk, a Blu-ray (registered trademark) disk, and a DVD. Note that HDD stands for hard disk drive. SD (registered trademark) stands for secure digital. CF stands for CompactFlash (registered trademark). DVD stands for digital versatile disk.

The communication station may have an input interface. The input interface is a port to be connected to an input device such as a mouse, a keyboard, and a touch panel. The input interface is specifically a universal serial bus (USB) terminal.

The communication station may have an output interface. The output interface is a port to be connected to a cable of an output device such as a display. The output interface is specifically a USB terminal or a high-definition multimedia interface (HDMI: registered trademark) terminal. The display is specifically a liquid-crystal display (LCD).

The communication program runs in the network system 500. The communication program is read by the processor and run by the processor. Not only the communication program but also an operating system (OS) is stored in the memory. The processor runs the communication program while running the OS. The communication program and the OS may be stored in the auxiliary storage device. The communication program and the OS which are stored in the auxiliary storage device are loaded to the memory and run by the processor. The communication program may be incorporated in the OS partly or entirely.

The communication station 100 may be provided with a plurality of processors that substitute for the processor. The plurality of processors share running of the communication program. Each processor is a device that runs the communication program, just as the processor does.

Data, information, signal values, and variables values which are utilized, processed, or outputted by the communication program are stored in the memory, the auxiliary storage device, or a register or cache memory in the processor.

The communication program causes the computer to execute the address assignment process (communication process). The term “process” of the address assignment process may be replaced by “program”, “program product”, “program-stored computer readable storage medium”, or “program-recorded computer readable recording medium”. The address assignment method (communication method) is a method that is performed by the network system 500 running the communication program.

The communication program may be stored in a computer readable recording medium and presented. The communication program may be presented in the form of a program product.

***Other Configurations***

The communication station 100 may be provided with an electronic circuit serving as the processor.

The electronic circuit is a dedicated electronic circuit that implements an address assignment function. The electronic circuit is specifically a single circuit, a composite circuit, a programmed processor, a parallel-programmed processor, a logic IC, a GA, an ASIC, or an FPGA. GA stands for gate array. ASIC stands for application specific integrated circuit. FPGA stands for field-programmable gate array.

In another modification, some of features of the address assignment function may be implemented by an electronic circuit, and the remaining features of the address assignment function may be implemented by software. Alternatively, some or all of the features of the address assignment function may be implemented by firmware.

The processor and the electronic circuit are also called processing circuitry. That is, the address assignment function is implemented by processing circuitry.

### Description of Effect of Present Embodiment

As described above, the network system 500 according to the present embodiment is constituted of a communication station having a processor such as a communication port and a CPU and provided with a mechanism that holds an address table on a storage device. If the communication station has two or more communication ports, the communication station has a function of relaying the communication ports. This relay function described above can be disconnected by an arbitrary means.

The network system 500 has a master station having one or more communication ports and a slave station having two or more communication ports. One or more master stations and one or more slave stations are daisy-chain connected. Alternatively, the network system 500 is a network system in which a slave station has three or more communication ports, and one or more master stations and one or more slave stations are tree-connected.

The master station and the slave station have a function of determining an address of an adjacent station and assigning the address to the adjacent station. After startup of the system or at an arbitrary timing, in response to a request from the adjacent slave station, the master station performs address assignment for the slave station adjacent to the master station. In response to a request from the adjacent slave station, the slave station that has completed address assignment determines an address of the adjacent slave station and assigns the address to the adjacent slave station.

In the network system 500 according to the present embodiment, the master station sends an alive check request to all the slave stations at fixed intervals. A slave station that has accepted the alive check request transmits its own information to the master station, so that the master station collects information of the slave station. Then, the master station, while confirming existence of the slave station on the network, grasps a connection relationship of the slave station on a basis of the above-mentioned collected information of the slave station, and communicates the grasped connection information to the slave station as an adjacent station notice.

With the communication process of the network system 500 according to the present embodiment, it is possible to perform address assignment on the basis of the connection relationship even if the slave station does not have an inherent address.

In the network system 500 according to the present embodiment, an address can be assigned to a slave station appropriately by a communication station adjacent to the slave station.

Therefore, with the network system 500 according to the present embodiment, an address can be assigned also to a slave station not having an inherent address, while avoiding concentration of a processing load to the master station.

### Embodiment 2

In the present embodiment, description will be made mainly about matters different from Embodiment 1 and matters additional to Embodiment 1.

In the present embodiment, a configuration having the same function as in Embodiment 1 will be denoted by the same reference sign, and its description will be omitted.

The present embodiment shows operations of removing a slave station 2 in the network configuration example 1 illustrated in FIG. 3 after automatic address assignment has been ended in Embodiment 1, and reconnecting the slave station with the original connection relationship after a fixed period of time.

The master station detects whether a slave station exists or not on a basis of an alive check request response, and updates adjacent station information. If an alive check request response is not sent from the slave station in response to the alive check request, the master station detects removal of the slave station or reconnection of the slave station. Then, the master station performs address reassignment automatically on a basis of the detection result.

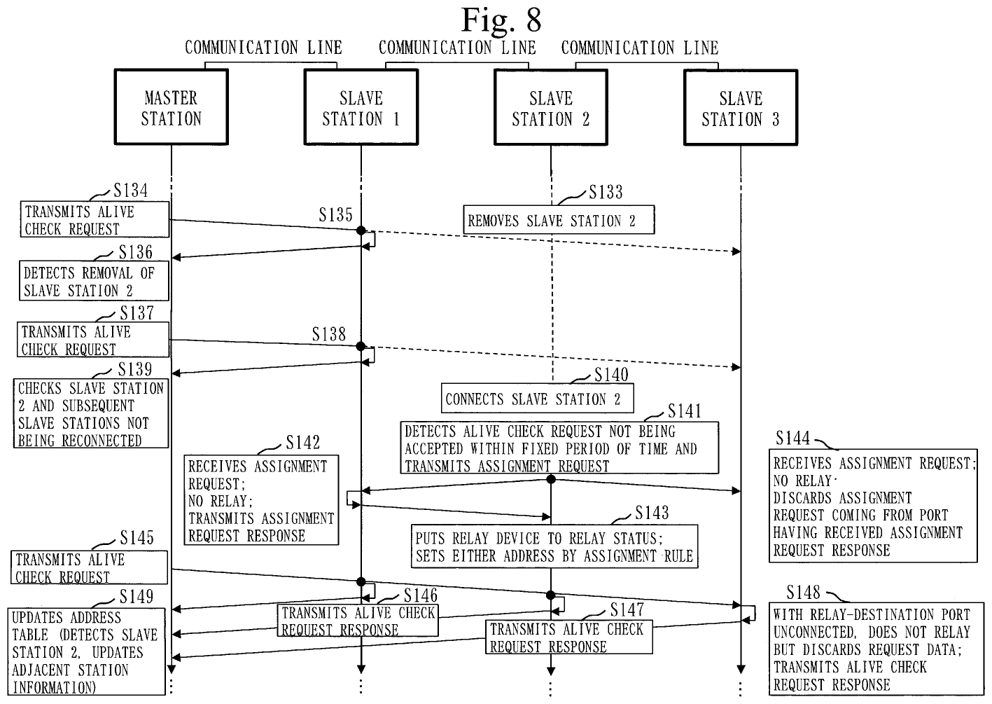

FIG. 8 is a sequence diagram illustrating a communication process of a network system 500 according to the present embodiment.

FIG. 8 presents a flow of reconnecting the slave station 2 in the present embodiment.

In a state where the address assignment process described in Embodiment 1 is ended and an address is assigned to all slave stations, the slave station 2 is removed (step S133).

As described in Embodiment 1, the master station transmits an alive check request at every fixed period of time by timer control (step S134).

After receiving the alive check request, a slave station 1 checks whether address assignment is completed and whether the slave station 1 itself is in the relay status. If both conditions are met, the slave station 1 includes the assigned its own address and adjacent station information it grasps into an alive check request response, and transmits the alive check request response to the master station (step S135). At this time, since it is detected from a connected status with the slave station 2 that a communication port not having received the alive check request is not in a connected status, the communication port does not relay the alive check request.

After a fixed period of time, the master station detects that an alive check request response is not received from the slave station 2 and subsequent slave stations (step S136). Since no alive check request response is received, the master station transmits the alive check request again (step S137). When transmitting the alive check request again, the master station transmits the alive check request an arbitrary number of times, or at a lapse of a period of time. If a response is not received in between the arbitrary number of times of transmission, the master station decides that the slave station 2 is completely removed from the network, and deletes the address and connection information from the address table.

Before the number of times the master station transmits the alive check request reaches an upper limit of the arbitrary number of times, the slave station is connected (step S140).

The slave station 2 detects that it does not accept the alive check request from the master within a fixed period of time, and transmits an alignment request (step S141). At this time, it is not clear whether the connection line is connected in the same manner as in the last time. Thus, the slave station 2 transmits the assignment request via all of its communication ports.

The slave station 1 receives the assignment request, calculates an address to be assigned to the slave station 2 with referring to its own address and the assignment rule, and transmits an assignment request response via a port at which the request was received (step S142). The assignment request contains the address to be assigned to the slave station 2 and the assignment rule.

Either one address is set to the slave station 2 according to the assignment rule, and the slave station 2 puts its relay device to the relay status (step S143). A slave station that has received the assignment request does not relay the received assignment request.

A slave station 3 receives the assignment request. However, since the assignment request is received via the communication port at which the slave station 3 accepted the assignment request response, the slave station 3 discards the request (step S144). The slave station 3 does not relay the assignment request.

The master station transmits the alive check request regularly by timer control (step S145).

After receiving the alive check request, the slave station that has received the alive check request checks whether address assignment is completed and whether the slave station itself is in the relay status. If both conditions are met, the slave station that has received the alive check request includes the assigned its own address and the alive check request response adjacent station information it grasps into the alive check request response, and transmits the alive check request response to the master station. Thus, the alive check request response is transmitted (steps S146, S147, S148).

The master station detects the slave station 2 from the accepted alive check request response, and updates the address table (step S149).

Having updated the adjacent station information, the master station transmits to a slave station having an address corresponding to the update, an adjacent station notice containing an adjacent station address of that slave.

The slave station that has received the adjacent station notice holds its own adjacent station information.

### Description of Effect of Present Embodiment

As described above, in the network system 500 according to the present embodiment, removal of a stave station can be detected, and the removed slave station can be reconnected.

### Embodiment 3

In the present embodiment, description will be made mainly about matters different from Embodiments 1 and 2 and matters additional to Embodiments 1 and 2.

In the present embodiment, a configuration having the same function as in Embodiments 1 and 2 will be denoted by the same reference sign, and its description will be omitted.

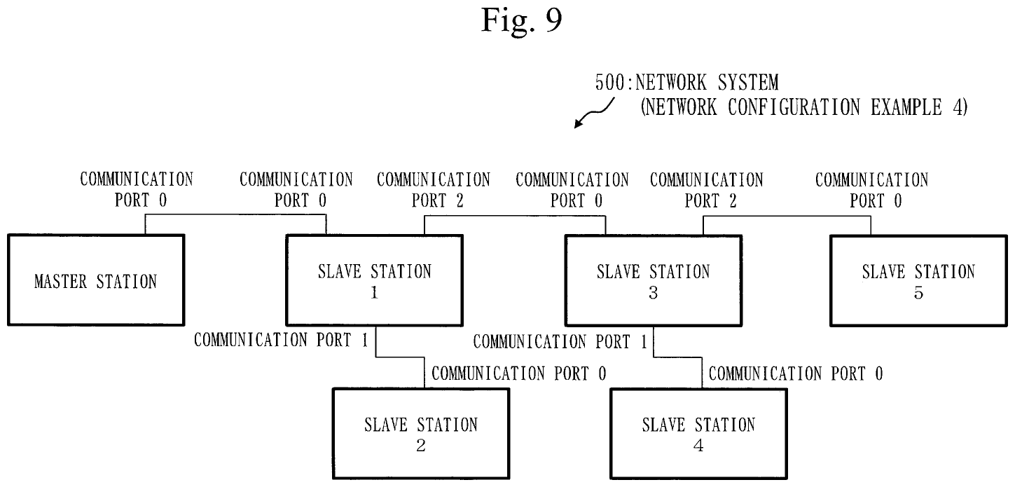

FIG. 9 is a diagram illustrating a network configuration example 4 according to the present embodiment.

A network system 500 according to the present embodiment has a tree connection with a branch configuration as illustrated in FIG. 9. In the network system 500 of FIG. 9, after startup, if no address information has been set and saved in a storage device in the past, the address table is emptied. If address information has been set and saved in the past, it is read onto the address table and used. Also, all relay devices of slave stations are put to a relay-disconnected status.

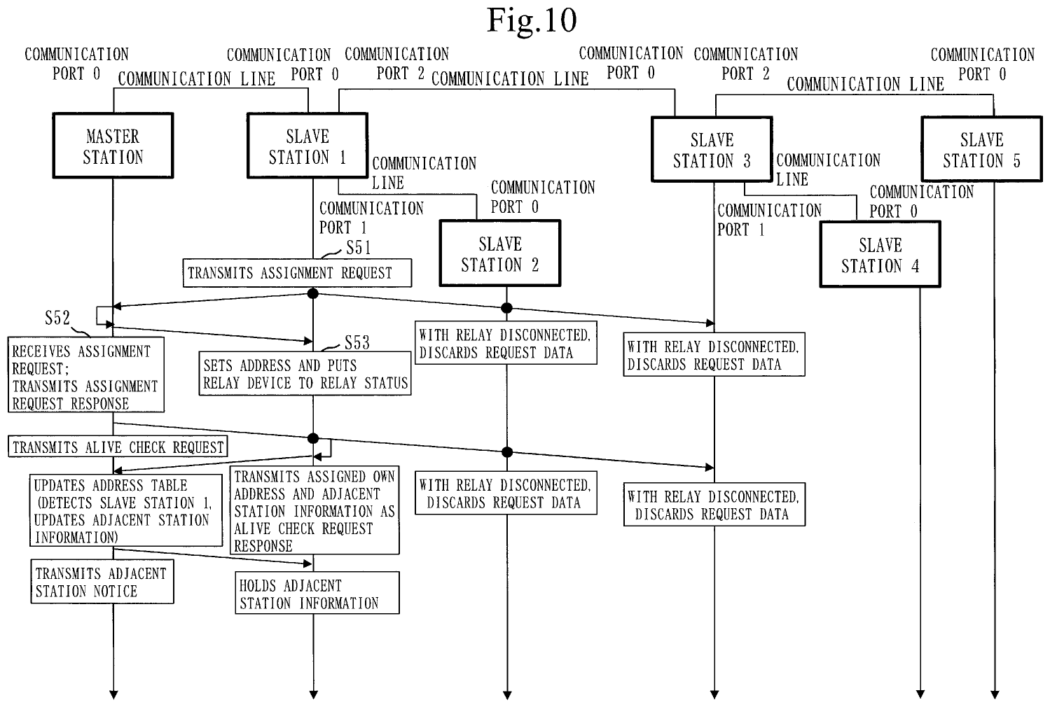

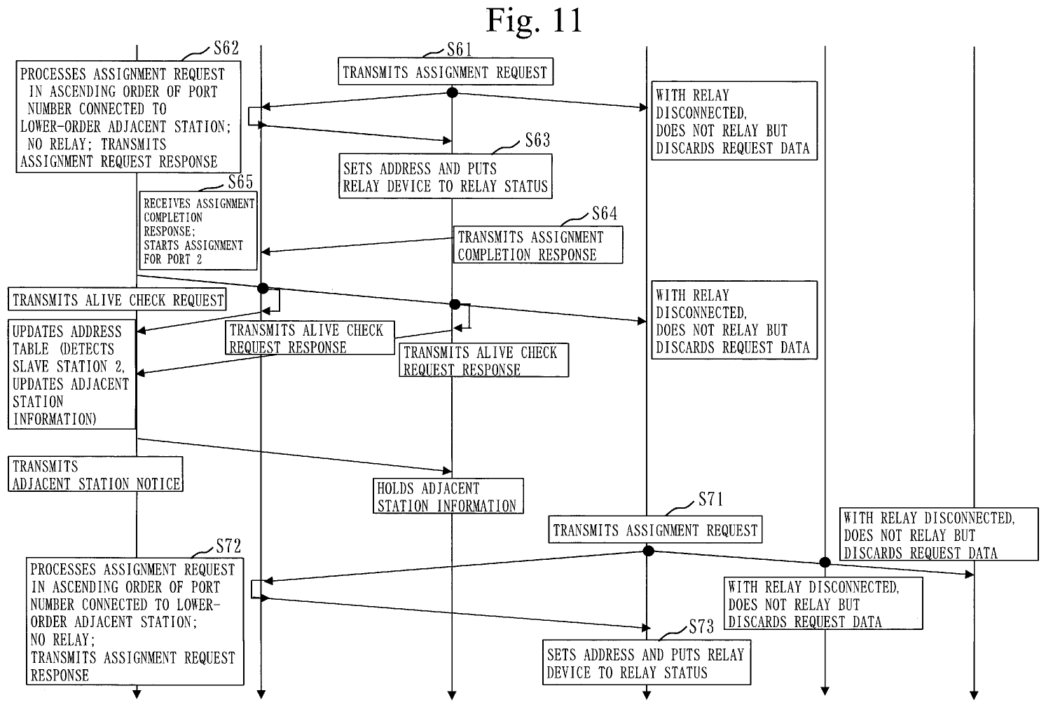

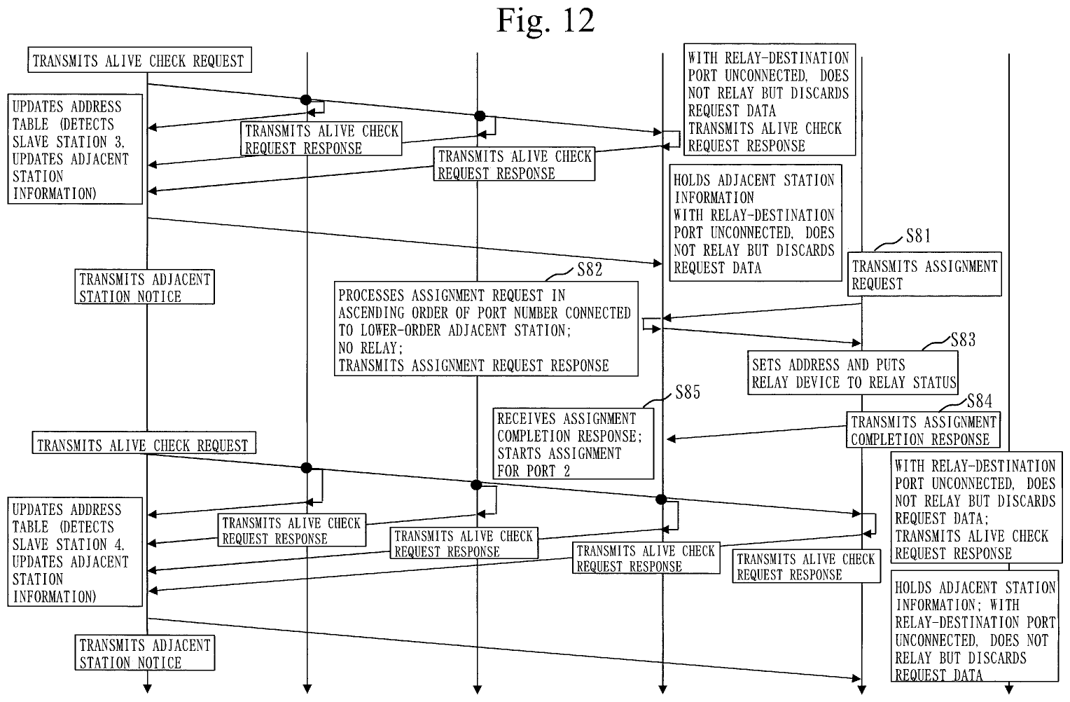

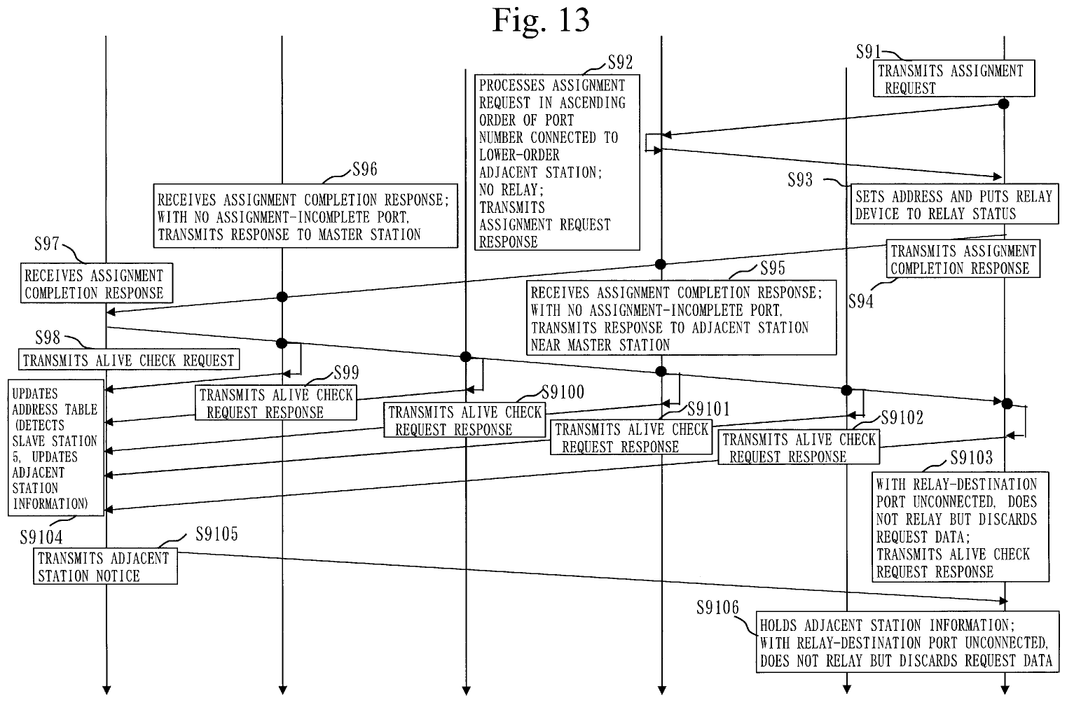

FIGS. 10 to 13 are sequence diagrams illustrating a communication process of the network system 500 according to the present embodiment. Note that FIGS. 10 to 13 are consecutive sequence diagrams.

FIGS. 10 to 13 present an address assignment process of the network configuration example 4 of FIG. 9.

It is not identified which port of each slave station the master station is connected to. Hence, each slave station transmits an assignment request to all its ports at fixed intervals using a timer or the like. At this time, slave stations that are not the master station discard the assignment request because their relay function is in a disconnected status after startup is ended.

The master station, upon reception of the assignment request from an adjacent slave station (a slave station 1 in FIG. 9) (step S51), determines an address to be assigned to the slave station (the slave station 1 in FIG. 9) from a start address initially set in the master station, and from the assignment rule. The master station sends an assignment request response via a port at which the request was received (step S52).

The adjacent slave station receives and analyzes the assignment request response, and uses the assigned address as its own address. If the assignment rule exists, the adjacent slave station holds it. The adjacent station that has accepted the assignment request response puts the relay device to the relay status, and stores the port at which the response was accepted (step S53).

The slave station 1 accepts an adjacent station notice transmitted from the master station and updates its own address table.

A slave station 2 and a slave station 3 are connected to branch ports (communication ports 1, 2) of the slave station 1. The slave station 2 transmits an assignment request at fixed intervals via its port connected to the branch port (step S61). In the initial state, it is not identified which communication port of the slave station 3 is near the master station. Hence, the slave station 3 transmits an assignment request via all its ports at fixed intervals using a timer or the like (step S71).

The slave station 1 receives assignment requests from the slave station 2 and the slave station 3 (steps S62, S72). A communication port (communication ports 1, 2) at which the received assignment request was accepted processes the assignment request in an ascending order of the communication port number (management port number) managed in the slave station 1. In the present case, the communication port 1 meets the condition. The slave station 1 calculates an address to be assigned by referring to its own address and the assignment rule, and transmits an assignment request response via its port at which the request was received. The assignment request response contains the address to be assigned to the slave station 2 and the assignment rule. A slave station that has received the assignment request does not relay the received assignment request.

The slave station 2 that has received the assignment request response assigns an address to itself on a basis of the received response data, and holds the assignment rule (step S63).

The slave station 2 completes address assignment and puts the relay device to the relay status. However, since there is not another slave station connected to the slave station 2, the slave station 2 sends an address assignment completion response to an immediately preceding station (step S64).

The slave station 1 receives the address assignment completion response, and recognizes that address assignment is completed for all slave stations whose communication ports are connected to the slave station 2. Thus, the slave station 1 processes the assignment request which is accepted via a communication port (communication port 2) whose management port number (communication port 2) is the second-smallest among communication ports possessed by the slave station 1 (step S65).

The slave station 3 that has accepted the assignment request response puts the relay device to the relay status, and holds setting of the address and the assignment rule (step S73).

At this time, the slave station 3 receives the assignment request from a slave station 4 and a slave station 5 (steps S81, S91). The slave station 3 performs an address assignment process in an ascending order of the management port number (sequentially from the communication port 1), in the same manner as in the process of the slave station 1 (S82, S92).

In this process, since the management port number of the port to which the slave station 4 is connected is small, address assignment is completed starting with the slave station 4.

The slave station 4 that has received an assignment request response puts the relay device to the relay status, holds setting of an address and the assignment rule, and puts the relay device to the relay status (step S83). Since there is not another slave station connected to the slave station 4, the slave station 4 sends an address assignment completion response to an immediately preceding station (step S84).

The slave station 3 receives the address assignment completion response, and recognizes that address assignment is completed for all slave stations whose communication ports are connected to the slave station 4. Thus, the slave station 3 processes the assignment request which is accepted via a communication port (communication port 2) whose port number is the second-smallest among communication ports possessed by the slave station 3 (step S85).

The slave station 3 processes the assignment of the slave station 5 and assigns an address to the slave station 5 (step S92).

The slave station 5 that has received an assignment request response puts the relay device to the relay status, and holds setting of the address and the assignment rule (step S93). The slave station 5 puts the relay device to the relay status. Since there is not another slave station connected to the slave station 5, the slave station 5 sends an address assignment completion request to an immediately preceding station (step S94).

The slave station 3 receives the address assignment completion response, and recognizes that address assignment is completed for all slave stations whose communication ports are connected to the slave station 5. Furthermore, the slave station 3 recognizes that address assignment is completed for all of its own communication ports, and sends an address assignment completion response to an immediately preceding station (step S95).

With the foregoing, the slave station 1 accepts the address assignment completion response, recognizes that address assignment is completed for all of its own communication ports, and sends an address assignment completion response to an immediately preceding station (step S96).

With the foregoing, the master station accepts the address assignment completion request, and recognizes that address assignment is completed in all the slave stations, thereby completing address assignment (step S97).

Further, the master station transmits an alive check request regularly to all the slave stations by timer control (step S98). As an example, a case of transmitting an alive check request to all the slave stations after step S97 will be described below.

The slave station that has accepted the alive check request checks whether address assignment is completed and whether the slave station itself is in the relay status. The slave station then includes the assigned its own address and adjacent station information it grasps into an alive check request response, and transmits the alive check request response to the master station (steps S99, S9100, S9101, S9102, S9103). If address assignment is not completed and the relay device is not in the relay status, the slave station does not respond. The adjacent station information contains its own communication port and an adjacent station address of an adjacent station which is connected to the communication port. Depending on the setting intervals of timer control, an alive check request may be transmitted during an address assignment flow, and a slave station may receive the alive check request. Only a slave station for which address assignment is completed and which is in the relay status responds.

The master station that has accepted the alive check request detects that the slave station which is the sender participates in the network, and updates an address list of the address table and adjacent station information of relevant addresses (steps S9104).

Having updated the adjacent station information, the master station transmits to a slave station having an address corresponding to the update, an adjacent station notice containing an adjacent station address of that slave station (step S9105).

The slave station that has received the adjacent station notice holds its own adjacent station information (step 9106).

### Description of Effect of Present Embodiment

As described above, in the network system 500 according to the present embodiment, an address-assigned slave station detects that there is not another adjacent station to be address-assigned by a communication port among its communication ports except a communication port near the master station, and transmits an address assignment completion notice via a communication port near the master station. An adjacent station that has accepted the above-mentioned notice, if there is an adjacent station to be address-assigned by a communication port among its own communication ports, performs address assignment in accordance with the method described in Embodiment 1. Alternatively, if there is not an adjacent station to be address-assigned by a communication port among its communication ports, the adjacent station transmits an address assignment completion notice repeatedly via its communication port near the master station. In this manner, an address assignment completion notice is transmitted to the master station, and the master station detects completion of address assignment of the network as a whole.

As described above, in the network system 500 according to the present embodiment, it is possible to perform address assignment on the basis of the connection relationship even if the slave station does not have an inherent address.

### Embodiment 4

In the present embodiment, description will be made mainly about matters different from Embodiments 1 through 3 and matters additional to Embodiments 1 through 3.

In the present embodiment, a configuration having the same function as in Embodiments 1 through 3 will be denoted by the same reference sign, and its description will be omitted.

With the means of Embodiment 1 or 3, a slave station can be assigned with an address automatically on a basis of a connection relationship between a master station and the slave station. Each slave station holds a communication port and an adjacent station address through an adjacent station notice from the master station.

With the above circumstances, in a branching network as illustrated in FIG. 9, if address assignment is performed automatically on a basis of the connection relationship between the master station and the slave station, each station can estimate an address of a slave device adjacently connected to itself. Hence, the master station and each slave station can perform unicast communication with using adjacent station information which is held already.

Upon reception of transmission data containing a destination address, each communication station of the plurality of communication stations determines, on a basis of its own address and the adjacent station information, a communication port to output the transmission data.

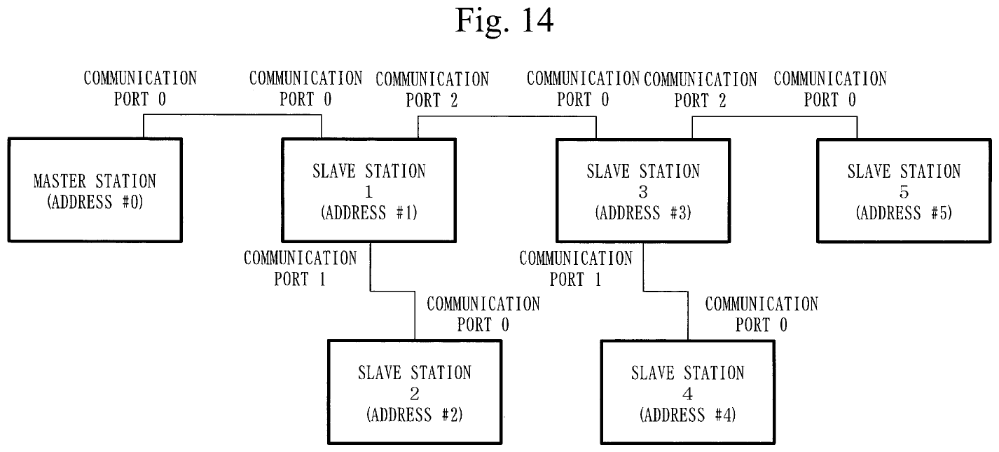

FIG. 14 is a diagram illustrating a state where an address assignment process has been performed for a network configuration example 4 according to the present embodiment.

In the state of FIG. 14, address assignment has been completed for the network configuration example 4 of FIG. 9 by Embodiment 3, and addresses are assigned to individual stations.

Unicasting from a station of address #0 to a station of address #4 will be studied.

A master station includes a destination address into transmission data and transmits the transmission data via a communication port 0.

A slave station 1 accepts the data from the master station and analyzes the destination address. Since a destination of the received data is not an address of the slave station 1, the slave station 1 forwards the received data on a basis of the adjacent station information it holds. A station adjacent to a communication port 1 of the slave station 1 has address #2 and a station adjacent to a communication port 2 of the slave station 1 has address #3. Therefore, it can be determined that address #4 is on the communication port 2 side. Thus, the slave station 1 transmits the data via its communication port 2.

A slave station 3 has accepted the communication data in accordance with the above-mentioned procedure. Since a destination of the received data is not an address of the slave station 3, the slave station 3 forwards the received data on a basis of the adjacent station information it holds. In this case, the slave station 3 transmits the reception data via its communication port 1.

The communication data is delivered to a slave station 4 (address #4) in the above manner.

### Description of Effect of Present Embodiment

As described above, in a network system 500 according to the present embodiment, since address assignment is performed for the slave stations in accordance with a connection order, simplified routing can be performed by unicast through designating a communication destination. Therefore, in the network system 500 according to the present embodiment, each station can forward data by unicast on a basis of the adjacent station information without grasping entire address information to be connected to itself.

### Embodiment 5

In the present embodiment, description will be made mainly about matters different from Embodiments 1 through 4 and matters additional to Embodiments 1 through 4.

In the present embodiment, a configuration having the same function as in Embodiments 1 through 4 will be denoted by the same reference sign, and its description will be omitted.

With the method described in Embodiment 1 or 3, an address is assigned automatically on a basis of a connection relationship between a master and a slave station. When, however, permitting address assignment that ignores the connection relationship intentionally, an address reassignment method is required. The present embodiment describes a method of setting an arbitrary address to an arbitrary slave station.

In Embodiment 1 or 3, the master station grasps the entire connection relationship from the adjacent station information via the alive check request and the alive check response. Hence, the master station can detect that an arbitrary address has not been assigned.

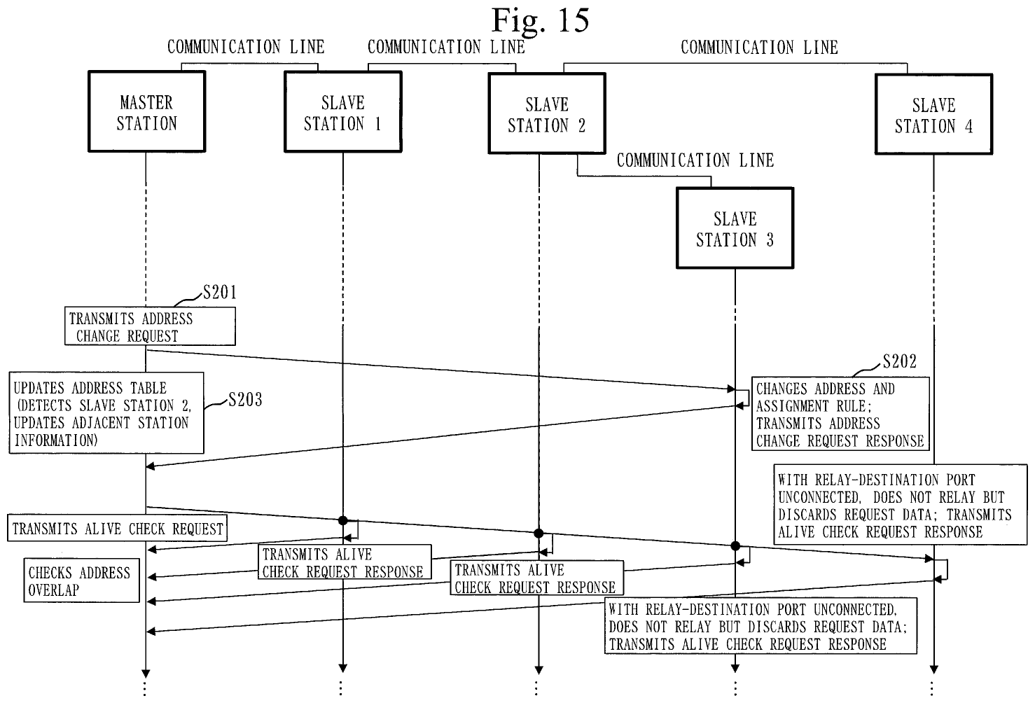

FIG. 15 is a sequence diagram illustrating a communication process of a network system 500 according to the present embodiment.

FIG. 15 illustrates an address change process flow in the network configuration example 3 of FIG. 5.

The master station transmits an address change assignment request about an already assigned address (step S201). The address change assignment request contains a changed address and an assignment rule.

A relevant slave station that has received the address change request sets the address contained in the request data as its own address, and holds the assignment rule. After that, the relevant slave station transmits an address change request response to the master station (step S202).

Alternatively, instead of using an address change request response, the slave station may receive an assignment request response through an alive check request and an alive check request response, may check whether an address is used, and may update an address table of the master station.

The master station that has received the address change request response updates the address table (step S203).

### Description of Effect of Present Embodiment

As described above, in the network system 500 according to the present embodiment, each station that performs address assignment for an adjacent station transmits and receives information concerning an address assignment method from the master station or the adjacent station, so that an address to be assigned to the adjacent station can be changed arbitrarily on a basis of the aforementioned information.

In the above manner, it has become possible to assign an address temporarily to a slave station not having an inherent address, and after that to assign an arbitrary address. Also, a target that requires address change is not limited to one slave. Address change can be made on every slave station.

### Embodiment 6

In the present embodiment, description will be made mainly about matters different from Embodiments 1 through 5 and matters additional to Embodiments 1 through 5.

In the present embodiment, a configuration having the same function as in Embodiments 1 through 5 will be denoted by the same reference sign, and its description will be omitted.

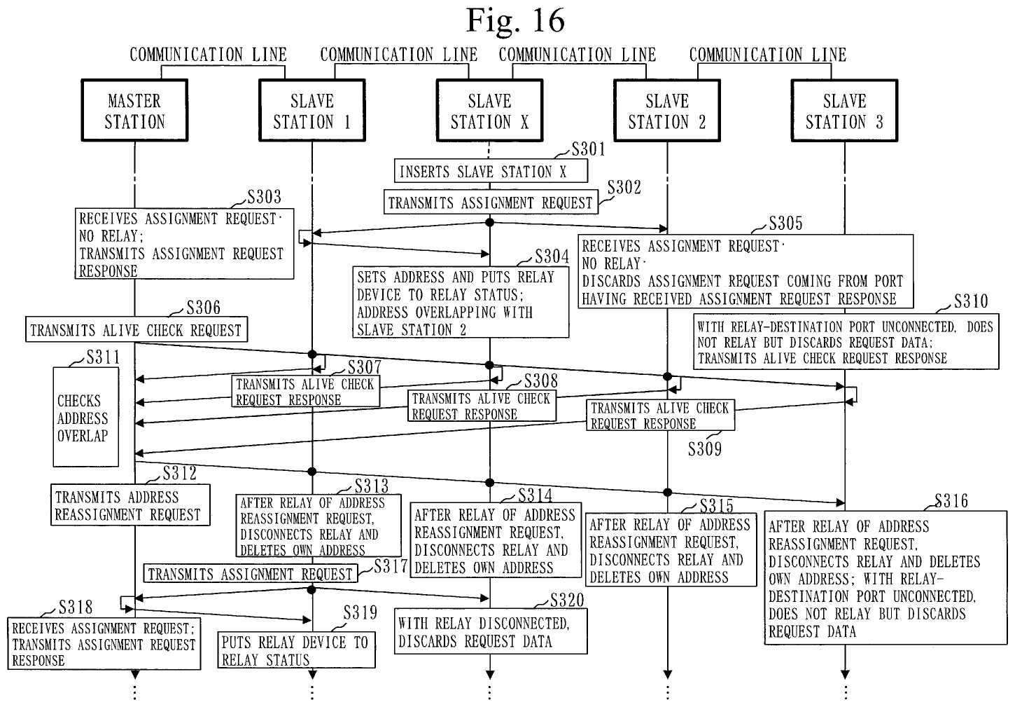

FIG. 16 is a sequence diagram illustrating a communication process of a network system 500 according to the present embodiment.

In the present embodiment, an address is assigned to all slave stations according to Embodiment 1 or 3. In this state, a slave X is inserted between a slave station 1 and a slave station 2 (step S301).

After startup, the slave station X transmits an assignment request via all its ports at fixed intervals by a timer or the like (step S302).

The slave station 1 receives the assignment request, calculates an address to be assigned to the slave station X by referring to its own address and the assignment rule, and transmits an assignment request response via a communication port at which the request was received. The assignment request response contains the address to be assigned to the slave station X and the assignment rule. Note that the address to be calculated here is the same as the address assigned to the slave station 2 before. The slave station that has received the assignment request does not relay the assignment request (step S303).

The slave station X that has received the assignment request response assigns an address to itself on a basis of received response data, and holds the assignment rule (step S304). Note that the address overlaps with the address of the slave station 2.

The assignment request transmitted by the slave station X is received by the slave station 2 as well. However, since the assignment request is received via the communication port at which the slave station 2 received the assignment request response, the slave station 2 discards the request. Also, the slave station 2 does not relay the assignment request (step S305).

The master station transmits the alive check request regularly to all slave stations by timer control (step S306).

The slave station that has accepted the alive check request checks whether address assignment is completed and whether the slave station itself is in the relay status. If both conditions are met, the slave station includes the assigned its own address and adjacent station information it grasps into an alive check request response, and transmits the alive check request response to the master station (steps S307, S308, S309, S310).

The master station that has accepted the alive check request response from each slave station detects that the same address as that assigned to the slave station 2 exists on the network (step S311). The master station having detected address overlap transmits an address reassignment request to all slave stations (step S312).

The master station that has received the address reassignment request relays the request, and after that disconnects the relay function, and deletes its own address and the adjacent station information (steps S313, S314, S315, S316). The address reassignment request can be transmitted only to slave stations connected to latter stages of the slave station that has detected address overlap.

If the address reassignment request is transmitted to all slave stations, the situation is the same as the start state of immediately after system startup of Embodiment 1, and automatic address assignment is performed by the same means as in Embodiment 1 or 3. Regarding the slave stations on the latter stages of the slave station having address overlap, addresses are automatically assigned to them through to before the slave station having address overlap. Then, automatic address assignment is performed for the salve stations on the latter stages of the slave station having address overlap, by the same means as in Embodiment 1 or 3.

### Description of Effect of Present Embodiment

As described above, in the network system 500 according to the present embodiment, an overlap state is detected in an address of a slave station on a basis of an alive check request response of the slave station against an alive check request transmitted from the master station, and insertion of a new slave station is recognized. After insertion of the slave station, the master station transmits an address reassignment request to each slave station. Hence, addresses can be reassigned to the slave stations automatically by the method described in Embodiment 1 in accordance with a connection order counted from the master station.

In the above manner, the slave station X becomes the slave station 2, and the former slave station 2 becomes the slave station 3. The addresses are assigned to the slave stations in accordance with a connection order counted from the master station.

### Embodiment 7

In the present embodiment, description will be made mainly about matters different from Embodiments 1 through 6 and matters additional to Embodiments 1 through 6.

In the present embodiment, a configuration having the same function as in Embodiments 1 through 6 will be denoted by the same reference sign, and its description will be omitted.

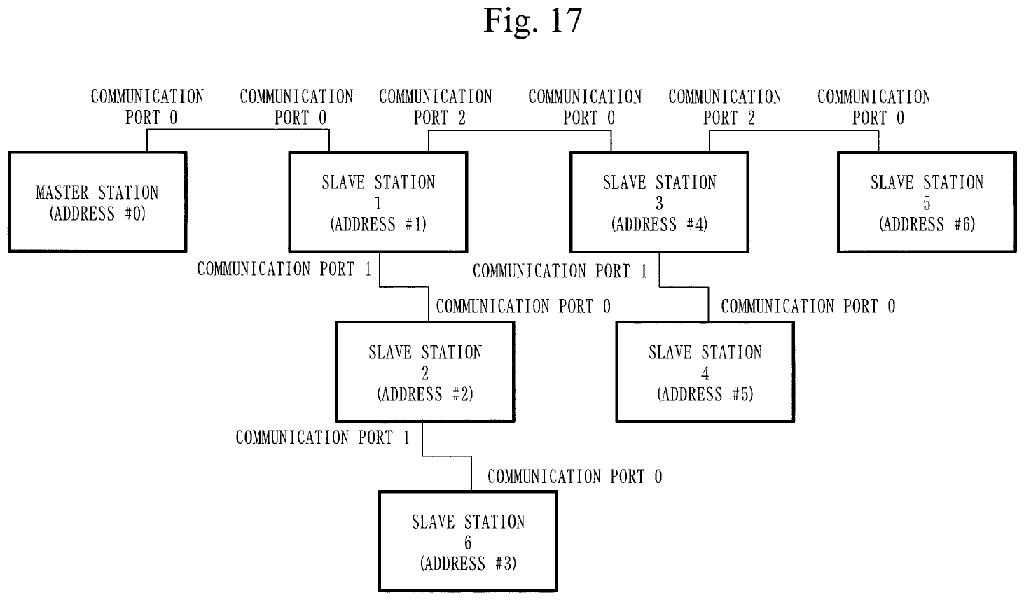

FIG. 17 is a diagram illustrating a state where an address assignment process has been performed for a network configuration example 4 according to the present embodiment and a slave station 6 is inserted in the network configuration example 4.

As illustrated in FIG. 17, when connecting a new slave station 6 to the slave station 2 in the network configuration example 4 of FIG. 14, if the means of Embodiment 6 is employed, the network system in operation must be suspended, and all addresses must be changed.

In view of this, the present embodiment presents a method of changing an address of only an additional communication station portion. The master station holds a formal address table which is inputted by a user of the network system and which indicates a relationship between communication ports and originally expected addresses.

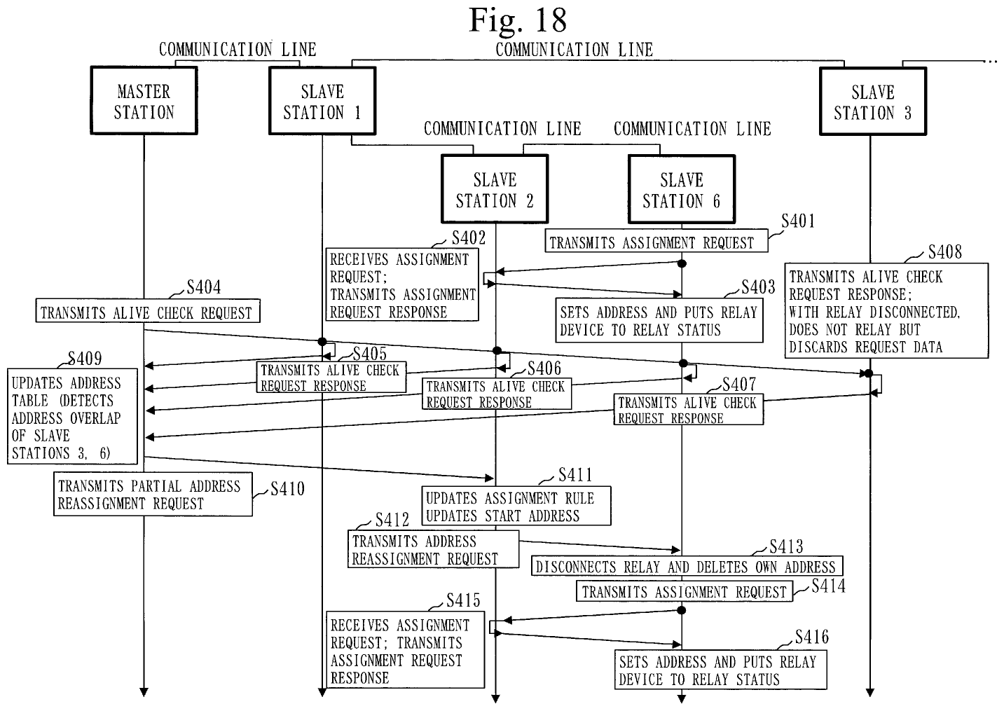

FIG. 18 is a sequence diagram illustrating a communication process of the network system 500 according to the present embodiment.

FIG. 18 illustrates an address resetting flow that is effected when a new slave station 6 is added in the network configuration example 4 of FIG. 14.

The slave station 6 transmits an assignment request (step S401). A slave station 2 receives the assignment request, calculates an address to be assigned to the slave station 6 by referring to its own address and the assignment rule, and transmits an assignment request response via a port at which the request was received (step S402). The assignment request response contains the address to be assigned to the slave station 6 and the assignment rule. Note that the address to be calculated here is the same as that assigned to the slave station 3.

The slave station 6 that has received the assignment request response assigns an address to itself on a basis of received response data, and holds the assignment rule (step S403).

The master station transmits an alive check request to all slave stations regularly by timer control (step S404).

The slave station that has accepted the alive check request response checks whether address assignment is completed and whether the slave station itself is in the relay status. If both conditions are met, the slave station includes the assigned its own address and adjacent station information it grasps into an alive check request response, and transmits the alive check request response to the master station (steps S405, S406, S407, S408).

The master station that as accepted the alive check request response from each slave station detects that the same address as that assigned to the slave station 3 exists on the network (step S409).

The master station having detected address overlap compares an address table collected by the alive check request with the formal address table, and detects a station (before-address-overlap adjacent station) connected to the slave station having overlap and near an immediately preceding master station. Alternatively, the master station can detect address assignment that is not based on a connection order, without using a formal address table. The master station transmits a partial address reassignment request to the detected before-address-overlap adjacent station (step S410). The partial address reassignment request contains the assignment rule, a start address, and a communication port number for which there is an adjacent station having address overlap.

The slave station 2 (before-address-overlap adjacent station) that has accepted the partial address reassignment request transmits an address reassignment request via its communication port for which there is an adjacent station having address overlap (step S411, S412).

The slave station 6 deletes its own address, changes the relay status to the disconnected status, and transmits an assignment request (step S413, S414).

The slave station 2 that has received the assignment request calculates an address to be assigned from the assignment rule and from the start address, and transmits a response via its port at which the assignment request was accepted (step S415).

The slave station 6 assigns an address to itself on a basis of the received response, and puts the relay status for the communication port to the relay status (step S416).

After that, an alive check request and an adjacent station notice are sent by the master station regularly in the same manner as in Embodiment 1.

### Description of Effect of Present Embodiment

As described above, in the network system 500 according to the present embodiment, an address is assigned to the slave station by the master station automatically, and the master station can grasp the connection relationship of all slave stations. By the address change request transmitted by the master station, an address of an arbitrary slave station can be reassigned to an arbitrary address.

As described above, in the network system 500 according to the present embodiment, an address of only an added communication station portion can be changed with using a formal address table.

In Embodiments 1 through 7 above, each function of the communication station of the network system is described as an independent function block. However, the communication station of the network system need not have the configuration as in the embodiments described above. Each function of the communication station of the network system may have any configuration as far as the function described in the embodiments described above can be implemented.

A plurality of portions of Embodiments 1 through 7 may be practiced by combination. Alternatively, of these embodiments, one portion may be practiced. Also, these embodiments may be practiced entirely or partially by any combination.

That is, in Embodiments 1 through 7, the individual embodiments may be combined freely; an arbitrary constituent element of each embodiment may be modified; and an arbitrary constituent element in each embodiment may be omitted.

The embodiments described above are essentially preferred exemplifications and are not intended to limit the scope of the present disclosure, the scope of an applied product of the present disclosure, and a scope of use of the present disclosure. Various modifications can be made in the above-described embodiments as necessary.

### REFERENCE SIGNS LIST

11: communication port; 12: relay device; 20: memory; 21: address table; 22: own address; 23: assignment rule; 100: communication station; 101: master station; 102: slave station; 110: communication unit; 120: processor; 121: communication unit; 500: network system.

1. A network system formed of a plurality of communication stations,
wherein the plurality of communication stations include a master station having one or more communication ports and a slave station having two or more communication ports,
wherein each communication station of the plurality of communication stations comprises a relay device which relays two or more communication ports of the communication station and which can be put to a relay-disconnected status,
wherein the slave station, in an initial state, puts the relay device to the relay-disconnected status and transmits an assignment request requesting address assignment for the slave station,
wherein the master station, in response to an assignment request from an adjacent slave station, performs address assignment for the slave station, and transmits an assignment request response containing an assigned address,
wherein the slave station, upon reception of the assignment request response, stores the address contained in the assignment request response to a memory, and puts the relay device to a relay status, and
wherein if the slave station receives the assignment request after address assignment for the slave station is completed, performs address assignment for a slave station being a sender of the assignment request instead of relaying the assignment request, and transmits an assignment request response containing an assigned address.

2. The network system according to claim 1,
wherein each communication station of the plurality of communication stations stores an assignment rule expressing an address assignment rule to the memory, and
wherein the communication station performs address assignment for the slave station being the sender of the assignment request according to the assignment rule.

3. The network system according to claim 1,
wherein the master station transmits an alive check request for checking existence of the slave station, and
wherein the slave station, upon reception of the alive check request, relays the alive check request, and transmits an alive check request response containing the own address.

4. The network system according to claim 3,
wherein the master station detects existence of the slave station being the sender of the alive check request response, acquires a connection relationship of the existence-detected slave station, as adjacent station information on a basis of the alive check request response from the slave station being the sender, and communicates the adjacent station information to the slave station.

5. The network system according to claim 4,
wherein the master station detects whether a slave station exists or not on a basis of the alive check request response, and updates the adjacent station information.

6. The network system according to claim 5,
wherein the master station detects an address overlap state of the slave station on a basis of the alive check request response, detects insertion of a new slave station from the address overlap state, and transmits an address reassignment request for the new slave station, and
wherein the new slave station is reassigned with an address in accordance with a connection order counted from the master station.

7. The network system according to claim 2,
wherein the communication station, upon reception of a change assignment request containing the assignment rule and requesting change of an address according to the assignment rule, changes an address of a slave station being a sender of the change assignment request according to the assignment rule.

8. The network system according to claim 1,
wherein the slave station, when assigned with an address, detects that there is not another adjacent slave station to be address-assigned by a communication port among communication ports of the slave station, and transmits an address assignment completion notice via a communication port near the master station, and
wherein a slave station that has accepted the notice, if there is an adjacent station to be address-assigned by a communication port among communication ports of the slave station, performs address assignment; alternatively, if there is not an adjacent station to be address-assigned by a communication port among the communication ports of the slave station, the slave station transmits an address assignment completion notice repeatedly via a communication port near the master station, so that an address assignment completion notice is transmitted to the master station, and the master station detects completion of address assignment of the network as a whole.

9. The network system according to claim 1,
wherein the slave station is assigned with an address automatically,
wherein the master station grasps a connection relationship of all slave stations, and
wherein the master station can reassign an address of an arbitrary slave station to an arbitrary address.

10. The network system according to claim 4,
wherein upon reception of transmission data containing a destination address, each communication station of the plurality of communication stations determines, on a basis of an address of the communication station and the adjacent station information, a communication port to output the transmission data.

11. A communication method employed in a network system formed of a plurality of communication stations,
wherein the plurality of communication stations include a master station having one or more communication ports and a slave station having two or more communication ports, and
wherein each communication station of the plurality of communication stations comprises a relay device which relays two or more communication ports of the communication station and which can be put to a relay-disconnected status,
the communication method comprising:
by the slave station, in an initial state, putting the relay device to the relay-disconnected status and transmitting an assignment request requesting address assignment for the slave station,
by the master station, in response to an assignment request from an adjacent slave station, performing address assignment for the slave station, and transmitting an assignment request response containing the assigned address,
by the slave station, upon reception of the assignment request response, storing the address contained in the assignment request response to a memory, and putting the relay device to a relay status, and
by the slave station, if receiving the assignment request after address assignment for the slave station is completed, performing address assignment for a slave station being a sender of the assignment request instead of relaying the assignment request, and transmitting an assignment request response containing an assigned address.

12. A non-transitory computer readable medium storing a communication program employed in a network system formed of a plurality of communication stations,
wherein the plurality of communication stations include a master station having one or more communication ports and a slave station having two or more communication ports, and
wherein each communication station of the plurality of communication stations comprises a relay device which relays two or more communication ports of the communication station and which can be put to a relay-disconnected status,
the communication program causing a computer to execute:
a process by the slave station, in an initial state, of putting the relay device to the relay-disconnected status and transmitting an assignment request requesting address assignment for the slave station,
a process by the master station, in response to an assignment request from an adjacent slave station, of performing address assignment for the slave station, and transmitting an assignment request response containing an assigned address,
a process by the slave station, upon reception of the assignment request response, of storing the address contained in the assignment request response to a memory, and putting the relay device to a relay status, and
a process by the slave station, if receiving the assignment request after address assignment for the slave station is completed, of performing address assignment for a slave station being a sender of the assignment request instead of relaying the assignment request, and transmitting an assignment request response containing an assigned address.
